(19) United States
(12) Patent Application Publication
(10) Pub. No.: US 2015/0228125 A1
(43) Pub. Date: Aug. 13, 2015

(54) TEST AND VALIDATION SYSTEM AND METHOD FOR TRANSPORTATION SYSTEMS

(71) Applicant: SPARQEE TECHNOLOGIES, LLC, Fullerton, CA (US)

(72) Inventors: Joseph Craig Silva, Fullerton, CA (US); Christopher T. Higgins, Placentia, CA (US)

(21) Appl. No.: 14/588,920

(22) Filed: Jan. 3, 2015

Related U.S. Application Data
(60) Provisional application No. 61/923,320, filed on Jan. 3, 2014.

(51) Int. Cl. G07B 15/06; H04B 1/3822; H04W 4/02

(52) U.S. Cl. CPC G07B 15/063; H04W 4/021; H04B 1/3822

(57) ABSTRACT

A system for validating transportation data comprises a server, a mobile device, and a first set of executable instructions on the mobile device configured to provide navigation instructions according to a test route. Expected transportation data readable by the server for the test route is included. A second set of executable instructions are configured to read an actual transportation data collected for the test route and to compare with the expected validation data.

### CROSS REFERENCE OF RELATED APPLICATIONS

The present application claims priority from U.S. Provisional Patent Application Ser. No. 61/923,320, entitled “TEST SYSTEM AND VALIDATION METHODOLOGIES ” filed on Jan. 3, 2014, the contents of which are hereby incorporated by reference in its entirety.

### FIELD OF THE INVENTION

This invention generally relates to a test and validation system and method for transportation systems. More specifically, the invention provides a system and method that supports testing of roadway transportation systems.

### BACKGROUND

Roadway transportation systems, such as tolling systems or speed sensor systems, require testing to validate the performance of the system, demonstrate functionality of the system, and/or controls to audit the system. Current testing practices are manually conducted, typically utilize pre-scripted routes, and require in-person interaction with control drivers that comprise test fleets to ensure test controls are in place.

To conduct testing control, drivers manually log their test activities. When testing has commenced, the test data must be manually logged or imported for comparison and validation against the recorded data in a back-office system or other recording facility for later data analysis. Analysts must then manually compare the test results against the toll system back office data using basic compare scripts or applications. This activity is cumbersome, time consuming and prone to human error.

### SUMMARY OF THE INVENTION

In order to solve the problems and shortcomings of the prior art, according to one preferred embodiment, a system for validating transportation data comprises a server; a mobile device; a first set of executable instructions on the mobile device configured to provide navigation instructions according to a test route; expected validation data readable by the server for the test route; and a second set of executable instructions configured to read actual collected transportation data for the test route and to compare with the expected validation data.

In another preferred embodiment, a method for validating transportation data comprises: providing navigation instructions according to a test route; reading expected validation data for the test route; reading actual collected transportation data for the test route; and comparing the actual collected transportation data with the expected validation data.

### BRIEF DESCRIPTION OF THE DRAWINGS

FIG. 1 is a diagrammatic representation of an exemplary wireless-based environment in which one embodiment may operate;

FIG. 2 is an example of a database with some database fields of a database table according to the embodiment of FIG. 1; and

FIG. 3 is a flow diagram illustrating steps that may be performed by software within software and hardware applications within the embodiments of FIGS. 1 and 2.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

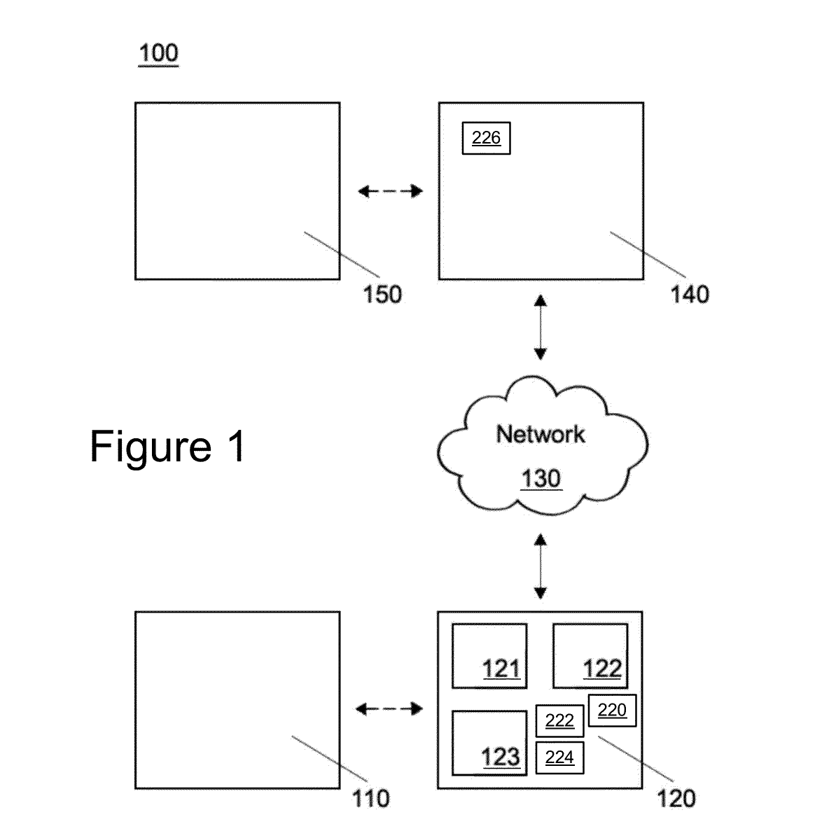

The system and method described herein tests and verifies toll and other tracking for roadway transportation systems in accordance with preferred embodiments of the present invention and is illustrated in FIGS. 1-3 wherein like reference numerals are used throughout to designate like elements.

With reference to FIG. 1, a diagrammatic representation of an exemplary network-based system is shown in which the system and method may operate according to one embodiment.

### Purpose

One embodiment provides a system and method that supports testing of roadway transportation systems. The system may automate, control, and create efficiencies in the testing of road transportation systems. By using a dedicated or integrated test system 140 that communicates with any number of mobile test devices 120 in mobile vehicles to plan, coordinate, orchestrate, collect, analyze and monitor road transportation systems during initial or routine testing and auditing, operators may significantly reduce the costs associated with testing, validation, and auditing. Overview of the System

FIG. 1 depicts a high-level block diagram depicting the various components which comprise this invention. The test system 140 is communicated with by a mobile test device 120 by wired or wireless means. Information may be transferred between the mobile test device 120 and the test system 140 over the network 130 to provide a simple mechanism for communicating with a multitude of mobile test devices.

The mobile test device 120 may contain communications and data collections functionality and is provided in order to create a distributed network of devices from which data can be collected when the mobile test device 120 resides in a vehicle or other test facility. The mobile test device 120 may comprise a single integrated device (such as a cellular phone with integrated features) or a standalone embedded device, either of which may utilize one or more applications 222 or 224 running on the device for purposes of communication and data collection. The hardware of the mobile test device 120 can have a number of subsystems including but not limited to a GPS subsystem 121 for tracking location and speed, a communications subsystem 122 for communicating with data networks, a thermometer subsystem 123 for monitoring temperature inside the cabin, or could include other faculties used to supplement data collection. In addition to onboard subsystems, the mobile test device 120 can also connect to secondary devices 110 via wired or wireless means. The secondary device 110 can include a device which can communicate over the vehicle's on board diagnostic (OBD) port of the vehicle (also known as the OBD-II port) or through other standard communication mechanisms to provide information such as speed, vehicle identification number (VIN), and mileage.

The test system 140 can be standalone or integrated into a secondary subsystem such as a toll road back-office system 150. Although the mechanism of a back-office 150 can be replaced by other facilities within the roadway transportation system, it is exemplary of a typical embodiment. The back-office system 150 may comprise the data collection mechanism for the roadway transportation system described herein.

### Mobile Test Device 120

In addition to the detailed description provided above, the mobile test device 120 can also include, in certain embodiments, the following characteristics.

Data collected from the test vehicle via the mobile test device 120 can be transferred by wireless or physical 130 means to the test system 140.

The embedded mobile test device 120 embodiment can track vehicles with wireless communication (cellular, wifi, GPS, or other radio frequency (RF) mechanisms) whilst connected to the vehicle.

The mobile test device 120 can report and collect travel information, which can be sent in real-time or later posted to the test system for validation.

The use of a mobile test device 120 that connects to the vehicle's OBD port either directly or through a secondary device 110 allows collection of speed and vehicle parameter data.

When connecting to a secondary device 110, the data collected from the other mechanisms, such as the OBD port, may include speed validation data, speed confidence data (comparing global positioning system (“GPS”) unit information with vehicle speed) and dead-reckoning data. Other data collected (for example from an OBD-II port) may include the VIN number for unique identification of the test vehicles.

The mobile test device 120 may provide an end user interface with an application downloaded/installed on a platform such as a mobile phone, GPS device or other original manufacturer installed vehicle technology. In one embodiment, the mobile test device 120 can be embedded into a vehicle without provision of an end-user interface/application.

An RF snooping subsystem 220 either in the mobile test device 120 or secondary device 110 allows the system to capture signals at various frequencies, which allows for real-time or post processing of the data captured. An example of this is if a vehicle drives through a toll gantry, which is equipped with an RF antenna, the system can capture all open communications between the gantry and vehicle equipped with an RF transponder (active or passive). This allows for the ability to monitor and audit the RF communication between a vehicle's transponder and a toll gantry, allowing the system to audit and verify that RF communications of the Toll System are working properly.

The data collected from the mobile test device 120 can be transferred to the test system by wireless and/or physical means. The test system 140 may reside on hardware that supports the test system 140 application. The test system 140 application may provide for data capture, storage, processing, viewing, analysis and reporting.

The mobile test device 120 may be able to achieve high accuracy tracking of test users by using a differential global positioning system (DGPS) receiver and/or dead reckoning to achieve centimeter-level positioning, allowing the test system to deduce the roadway lane-level position of a vehicle. A differential reference station could be provided. The lane-level position of a vehicle can be applied to civil drawings of the roadway for mapping and survey for truth comparison against the test user position. This mechanism could be included in the mobile test device 120 or the secondary device 110.

The mobile test device 120 or the secondary device 110 may include a navigation subsystem 222 which can be utilized to provide test users with audible and/or visual guidance using waypoints that are connected with a navigation system to guide the test user during test execution and also to automatically note errors performed during testing.

The mobile test device 120, secondary device 110, or test system 140 application may include a geo-fencing subsystem 224 to enable identification and position/path logging of test vehicles. The identification and position/path logging identifies if a test vehicle is on the correct test path. Geo-fencing can provide test users an audible and/or visual indication if the test user is off course or has completed their test trips or passes.

### Test System 140

The test system 140 can also include, in certain embodiments, the following characteristics.

Test system 140 data may include vehicle location, speed, distance travelled, vehicle identification information, toll transponder number, toll transactions, license plate number, test data captured, testing instructions, payment instructions and mechanisms, communications mechanisms, and/or dispatching capabilities.

Test system 140 data collected from the test application can be transmitted in real-time using wireless communications to provide live position updates and progress of testing to the test conductors. The test system 140 data can also be stored on the end-user device and transferred post-testing for the collection of test data.

The test system 140 console may comprise a tool that manages the toll system testing. The test system 140 console may be used to create the test plan and procedures, and to log the system controls. Further, the test system may be managed throughout testing to inform drivers, change test procedures, review test progress and report on results from testing.

The test system 140 that captures the test data can reside geographically separated from the roadway transportation system during testing and/or ongoing system validation. The test system 140 will be connected to a test system application console to view, process and analyze the test data.

During testing, test data can be queued for the purpose of trip construction or other processing before transfer to the test system application central console.

The test system 140 can be used for temporary or ongoing validation of systems.

Advanced monitoring capabilities of the testing system 140 can be provided which can include the use of simple network management protocol (SNMP) messages and alerts that provide status and health monitoring of the entire test system 140. The messages and alerts can automatically notify test conductors of systems issues and test discrepancies, such as missing test data that may include transactions, trips or invalidities.

In one embodiment, the test system 140 may include test users who can register for a testing program by downloading/installing a mobile test application 226 on their mobile test device 120 wherein the mobile test device 120 includes a portable or embedded communications interface, such as a mobile phone or other computing device. Users of the test system 140 may thus include the general public who can download/install the test application 226 and register to participate in the testing onto their mobile test device 120. The test system 140 may allow test conductors to identify the test users, track them via wireless communication mechanisms and provide directions to the test users.

The test system 140 may provide information to the test users which can include conduct information, instructions for the test driver to use to execute test passes or laps on the transportation system and updates to the driver such as progress updates or changes to the testing.

With the test system 140, the real-time or near-real-time position of the test users can be used by test conductors/coordinators to orchestrate tests (scripted or ad hoc), track testers, provide instructions and collect data for further analysis from a central console. Test data created can be represented on a map on the test system 140 application console.

The test system 140 may provide test instructions presented to the test user allowing drivers to sign up or nominate to perform certain test trips and test passes.

The test system 140 can include gamification techniques which can be used during testing where test users can earn points or credits for performing test plans, test passes and test laps. The points or value for the completion of test procedures is configurable. Drivers can select or bid for trips within a trip queue. By dynamically or manually increasing the point value of the trip, the test coordinators can increase the probability that a particular trip will be taken within a defined period.

For the purposes of testing a toll system, the test system 140 can connect to the roadway transportation system back-office 150. For situations such as toll road systems, the comparison of transaction and/or trip data collected from the test vehicles and the transaction and/or trip data collected from the tolling system provides validation of the system testing. The controls that can be established during toll system testing provides high confidence in the test data; the key control being the ability to track vehicles with high levels of accuracy. Customized reporting and analysis modules are also provided which provide for rapid adaptation of the system for customized reporting and analysis.

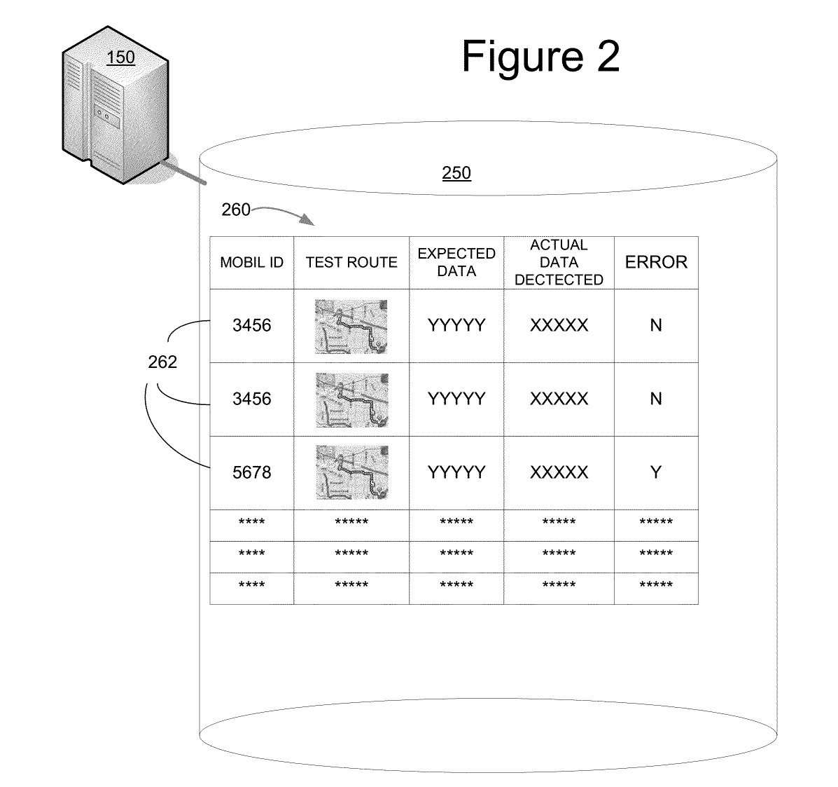

With reference to FIG. 2, an example of a database 250 with some database fields in records 262 of a database table 260 according to the embodiment of FIG. 1 is shown. The toll system back-office 150 may comprise a server containing the database 262. Some of the fields in the records 262 may comprise, by way of example, a mobile id to identify the mobile test device 120, each test root assigned to each mobile test device 120, the expected tolls for each root (toll system back-office data), and the actual tolls charged (collected test system data) to the user of the mobile test device 120 for comparison to the expected tolls.

In one embodiment, automatic validation can be performed using the comparison of the collected test system 140 data and, in the case of toll road systems, the toll system back-office 150 data. Automatic validation of the test data can be performed in parallel with test conduct to expedite the testing process.

When test drivers begin testing they can scan a transponder, take a picture of the license plate and the test vehicle using the mobile test device 120. This information can be used to validate that the transponder is associated with the correct test vehicle to provide control of testing activities. QR codes, NFC, Bluetooth, WiFi, and/or connection to secondary devices 110 may also be used to uniquely identify a vehicle, license plate, and/or transponder in the vehicle. The test system 140 can provide feedback if the code/tag is the correct number. Using optical character recognition (OCR) capabilities at either the mobile test device 120, the test system 140, or secondary device 110 to decipher the license plate number in the picture of the vehicle, the test system 140 can confirm that the correct license plate and transponder are paired on the test vehicle.

Testing can be further automated by utilizing autonomous (driverless) vehicles to perform the test passes and test activities. Test conductors can pre-program trips into the test system 140 and manually or wirelessly push routes to be driven by an autonomous vehicle. Autonomous test vehicles can be orchestrated and controlled with high confidence through a single interface.

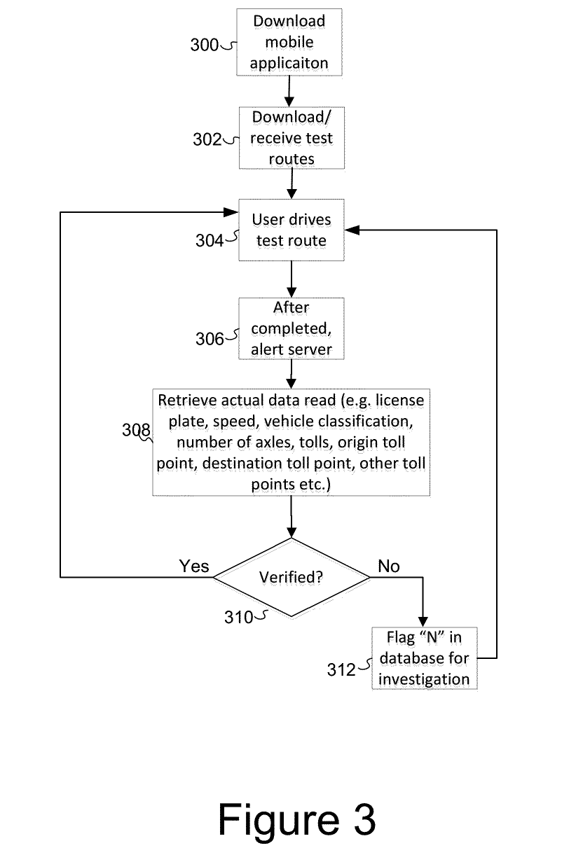

With reference to FIG. 3, a flow diagram illustrates steps that may be performed by software within software and hardware applications within the system 100 according to the embodiments of FIGS. 1 and 2. In step 300, the user of the mobile device 120 may download the application test system application 226 to the mobile test device (in embodiments where the application 226 is not pre-installed). In step 302, the test routes are downloaded from the database 260 from server 150 through the network 130 (in embodiments where the routes are not preinstalled).

In step 304, the user with the mobile device 120 may the drive one or more of the test routes. In step 306, when each test route is completed, the server may be alerted by the test system application 226 may send a message to the server 150 to indicate that the test route is completed. At that time, in step 308, the server 150 may retrieve the actual information detected by the road sensors (e.g. license plate, speed, vehicle classification, number of axles, tolls, origin toll point, destination toll point, other toll points .etc.) for the user of the mobile device from the relevant road administration agency. In step 310, the server may store the actual detected information in database 260 and then compare with the expected validation data for the completed route. If the expected data does not match the actual detected data, then in step 312, a flag may be set in the database 260 to alert personnel to investigate the discrepancy. Those of skill in the art would recognize that the instructions executable on a processor to perform each of these steps may be located in various hardware pieces of the system, and the above is merely exemplary. Further, in some embodiments, each of actual data collected may be validated in real time instead of after the whole test route is completed by a user.

In one embodiment, a benefit of this system is that a smartphone may be used in order to automatically transfer data pertaining to an individual driver's habits - for example, speed and location can be provided and compared automatically. The system could calculate toll amounts based on that information. Other pieces of information could also be included with user input-vehicle classification, axle count, etc.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for validating transportation data comprising:
a server;
a mobile device;
a first set of executable instructions on the mobile device configured to provide navigation instructions according to a test route;
expected validation data readable by the server for the test route; and
a second set of executable instructions configured to read an actual transportation data collected for the test route and to compare with the expected validation data.

2. The system of claim 1, wherein the second set of executable instructions are further configured to set an alert flag if expected validation data does not equal the actual transportation data collected.

3. The system of claim 1, wherein the first set of executable instructions are configured to download one or more test routes from the server.

4. The system of claim 3, wherein the second set of executable instructions are further configured to read a different expected validation data for each test route, and to compare said each different expected validation data to actual transportation data collected for each test route.

5. The system of claim 1, wherein the mobile device contains a wireless radio to communicate over a wireless network.

6. The system of claim 5, wherein the mobile device comprises a mobile phone.

7. The system of claim 6, wherein the mobile device contains a global positioning system.

8. The system of claim 7, wherein the mobile device is configured to transmit its position in real time to allow the server to compare individual transportation data collected to individual expected validation data.

9. The system of claim 1, wherein the actual transportation data collected comprises data selected from the group consisting of: license plate data, speed data, vehicle classification, number of axles data, toll data, origin toll point, destination toll point and other toll points.

10. A method for validating tolls comprising:
providing navigation instructions according to a test route;
reading expected validation data for the test route;
reading actual transportation data collected for the test route; and
comparing the actual transportation data collected to the expected validation data.

11. The method of claim 10, further comprising setting an alert flag if actual transportation data does not equal the expected validation data.

12. The method of claim 10, further comprising downloading one or more test routes.

13. The method of claim 12, further comprising reading a different expected validation data for each route, and comparing said each different expected validation data to actual transportation data collected for each test route.

14. The method of claim 13, further comprising comparing individual actual transportation data collected to individual expected validation data in real-time.

15. The method of claim 14, wherein the actual transportation data collected comprises data selected from the group consisting of: license plate data, speed data, vehicle classification, number of axles data toll data, origin toll point, destination toll point and other toll points.
